(19) United States
(12) Patent Application Publication
(10) Pub. No.: US 2012/0136815 A1
(43) Pub. Date: May 31, 2012

(54) Display Device and Display Method

(76) Inventor: Masahiro Ozawa, Tokyo (JP)

(21) Appl. No.: 13/197,522

(22) Filed: Aug. 3, 2011

(30) Foreign Application Priority Data
Nov. 30, 2010 (JP) 2010-267129

(51) Int. Cl. G06F 15/18

(52) U.S. Cl. 706/12

(57) ABSTRACT

According to one embodiment, a display device includes an operation module, a display module, a recorder, a compiling module, and a display controller. The operation module receives an operation from a user. The display module displays content in accordance with the operation. The recorder measures the display time of the content that is being displayed and records the display time for each content. The compiling module compiles statistical information relating to a preference of the user based on the display time recorded for each content. The display controller displays, among contents that have been previously stored, content matching with the preference of the user indicated by the statistical information on the display module.

### CROSS-REFERENCE TO RELATED APPLICATIONS

This application is based upon and claims the benefit of priority from Japanese Patent Application No. 2010-267129, filed Nov. 30, 2010, the entire contents of which are incorporated herein by reference.

### FIELD

Embodiments described herein relate generally to a display device and a display method.

### BACKGROUND

In recent years, digitization of content such as books, magazines, newspapers, advertisements, and the like has been advanced. To display the content, there have been known display devices such as electronic book readers. Some of the conventional display devices record a total of display time of each page of content that is being read by a user and displays pages each assigned an index in the descending order of the display time to quickly obtain useful information in contents browsed in the past.

The conventional display devices allow the user to quickly obtain information useful for him/her in contents browsed in the past. Meanwhile, the conventional display devices cannot provide content that the user is likely to be interested in among a plurality of contents including those already browsed and those yet to be browsed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a configuration of a system according to an embodiment;

FIG. 2 is an exemplary block diagram of a configuration of a display device in the embodiment;

FIG. 3 is an exemplary flowchart of the operation of the display device in the embodiment;

FIG. 4 is an exemplary conceptual view of display of an advertisement matching with the preference of a user in the embodiment;

FIG. 5 is an exemplary conceptual view of display of a learning exercise matching with the preference of a user in the embodiment;

FIG. 6 is an exemplary conceptual view of display of an article matching with the preference of a user in the embodiment; and

FIG. 7 is an exemplary conceptual view of display of a digest of articles matching with the preference of a user in the embodiment.

### DETAILED DESCRIPTION

In general, according to one embodiment, a display device comprises an operation module, a display module, a recorder, a compiling module, and a display controller. The operation module is configured to receive an operation from a user. The display module is configured to display content in accordance with the operation. The recorder is configured to measure the display time of the content that is being displayed and record the display time for each content. The compiling module is configured to compile statistical information relating to a preference of the user based on the display time recorded for each content. The display controller is configured to display, among contents that have been previously stored, content matching with the preference of the user indicated by the statistical information on the display module.

Exemplary embodiments will be described in detail below with reference to the accompanying drawings. First, a description will be given of an outline of a system comprising a display device according to an embodiment.

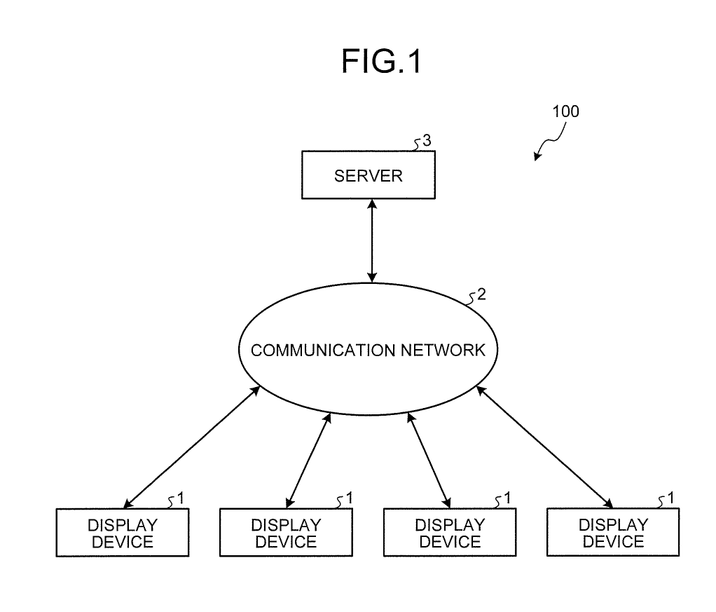

FIG. 1 is a block diagram of a configuration of a system 100. As illustrated in FIG. 1, the system 100 comprises display devices 1 of the embodiment and a server 3. The display devices 1 and the server 3 are connected to one another with a communication network 2 such as the Internet or a local area network (LAN) in a communicatable manner.

The display devices 1 are terminals that display digitized content of books, magazines, newspapers, advertisements, and the like. More specifically, each of the display devices 1 may be a personal computer (PC), a personal digital assistant (PDA), a mobile phone, an electronic book reader, or the like. The server 3 provides information in response to a request to various devices (for example, the display devices 1) in communication connection with the server 3 via the communication network 2 and collects information from various devices. More specifically, the server 3 distributes digitized content, information obtained by compiling statistical information (which will be described in detail later) collected from the display devices 1 in communication connection with the server 3 via the communication network 2, or the like.

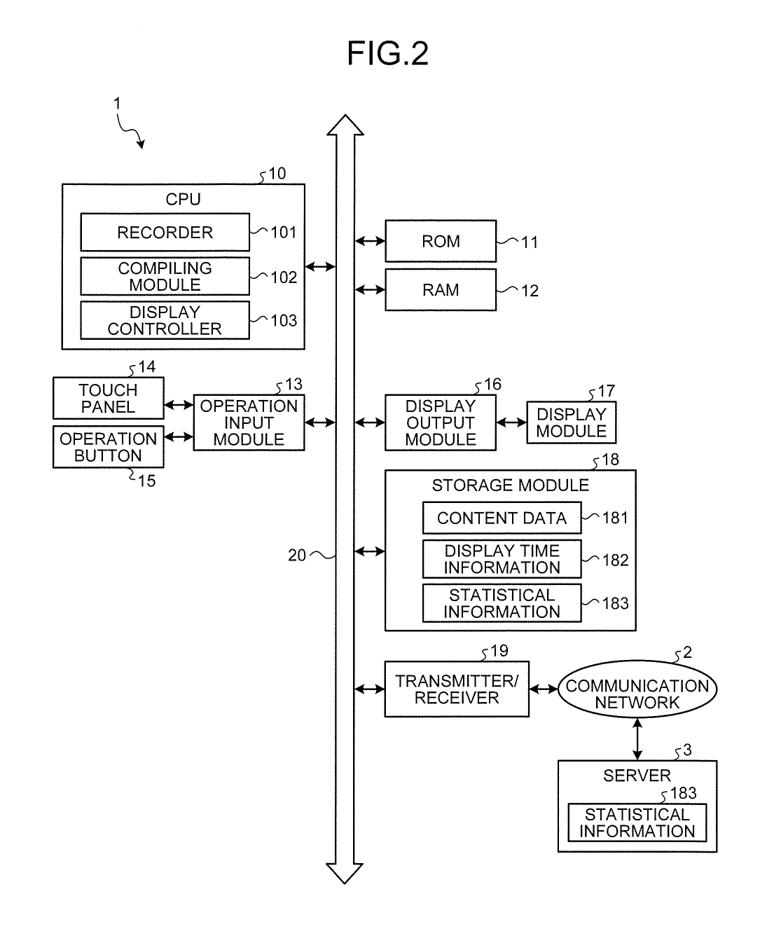

FIG. 2 is a block diagram of a configuration of the display device 1 of the embodiment. As illustrated in FIG. 2, the display device 1 comprises a central processing unit (CPU) 10 a read only memory (ROM) 11, a random access memory (RAM) 12, an operation input module 13, a touch panel 14, an operation button 15, a display output module 16, a display module 17, a storage module 18, and a transmitter/receiver 19, which are connected via a bus 20.

The CPU 10 loads programs stored in the ROM 11 into a work area in the RAM 12 and sequentially executes the programs to control the overall operation of the display device 1. More specifically, the CPU 10 executes the programs to implement functions as a recorder 101, a compiling module 102, and a display controller 103 (which will be described in detail later). The ROM 11 stores programs to be executed by the CPU 10, and the like. The RAM 12 provides the CPU 10 with a work area to execute the programs. The operation input module 13 receives an operation input from a user through the touch panel 14, the operation button 15, or the like. The operation from a user received by the operation input module 13 is output to the CPU 10 as an operation signal.

The display output module 16 outputs display data to the display module 17 such as a liquid crystal display (LCD) under the control of the CPU 10. The display module 17 performs screen display with the display data output from the display output module 16. Accordingly, in the display device 1, digitized content or the like is displayed on a screen of the display module 17 under the control of the CPU 10. For example, the display module 17 displays content or the like selected in accordance with an operation received from a user by the operation input module 13 among contents included in content data 181 stored in the storage module 18.

The storage module 18 is a mass storage medium such as, for example, a hard disk drive (HDD), a solid state drive (SSD), and a digital versatile disc (DVD) and stores various types of information in a readable/writable manner. More specifically, the storage module 18 stores the content data 181, display time information 182, statistical information 183, and the like. The content data 181 is data obtained by digitizing content of books, magazines, newspapers, advertisements, and the like in a predetermined file format. The display time information 182 is information in which display time for each content is recorded. The statistical information 183 is information obtained by compiling statistical data relating to the preference of a user based on the display time for each content. The content data 181 and the statistical information 183 stored by the storage module 18 may be data obtained from the server 3 by the transmitter/receiver 19, which will be described later.

The transmitter/receiver 19 transmits and receives data using a predetermined communication protocol to and from a device, such as the server 3, communicably connected via the communication network 2 under the control of the CPU 10. More specifically, the transmitter/receiver 19 transmits the statistical information 183 stored in the storage module 18 to the server 3 communicably connected via the communication network 2 under the control of the CPU 10. Thus, the statistical information 183 received from a plurality of display devices 1 in communication connection with the server 3 via the communication network 2 can be compiled in the server 3. Under the control of the CPU 10, the transmitter/receiver 19 receives from the server 3 the statistical information 183 that the server 3 has compiled from the plurality of display devices 1, the content data 181 distributed by the server 3, and the like. Accordingly, in the display devices 1, content can be displayed using the statistical information 183 compiled in the server 3 (which described in detail later).

A description will then be given of the recorder 101, the compiling module 102, and the display controller 103 that are functional modules implemented by the CPU 10 executing programs.

The recorder 101 measures the display time of content that is being displayed on the display module 17 in accordance with an operation received from a user through the operation input module 13 and records the measured display time in the display time information 182 together with a content ID and the like. The content ID is uniquely assigned to the content for identifying the content.

For example, for an article (content) included in a predetermined page of a newspaper having a plurality of pages, the recorder 101 measures the display time of a page in which the content is included and records the measured display time in the display time information 182 together with a content ID and the like. When the display time of the same content ID has already been recorded in the display time information 182, newly measured display time is added thereto. If a plurality of contents are included in one page and one of the contents is enlarged to be displayed, the recorder 101 may measure the display time of the content enlarged to be displayed and record the measured display time in the display time information 182 together with a content ID and the like.

The recorder 101 may record a term such as a word and a keyword included in the content that is being displayed on the display module 17 in the display time information 182 as a term relating to the content together with a content ID and the like. When the content that is being displayed is text data, the term is extracted from the title or the like included in the text data. On the other hand, when the content that is being displayed is image data, the term is extracted from the title or the like recognized as characters by optical character recognition (OCR) processing.

The compiling module 102 compiles statistical information relating to the preference of a user based on the display time recorded for each content in the display time information 182. The compiling module 102 records the compiled statistical information in the storage module 18 as the statistical information 183. The statistical information 183 is information obtained by, for example, compiling the display time of contents belonging to an attribute with respect to each attribute of content. The statistical information 183 is represented by the length of the compiled display time that indicates which attribute a user has a strong preference for. Meta information indicating an attribute is attached to each content. The compiling module 102 compiles the display time for each attribute based on the meta information attached to each content. The attribute to which content belongs may be a category such as “politics”, “economics”, “science”, “health”, and “region”, a sub-category indicating a tourist site such as “sea X” and “mountain Y” in the “region”, or the like. For example, when the display time of the category “politics” is long, it is determined that a user has a strong preference for the “politics”.

The compiling module 102 may compile the display time of a term as the statistical information 183 for each term relating to contents recorded in the display time information 182. In this case, the display time of contents including a common term is compiled. This makes it possible to judge a strong preference of a user from the compiled display time. For example, when the display time of contents including a term “currency exchange” is long, it is determined that the user has a strong preference for “currency exchange”. The compiling module 102 may compile the strength of a preference for each attribute to which a term belongs based on dictionary data and the like. For example, when the display time of contents including terms “currency exchange”, “stock price”, and the like is long, it is determined that a user has a strong preference for “economics” to which “currency exchange” and “stock price” belong.

The display controller 103 displays, among contents included in the content data 181 stored in the storage module 18, content matching with the preference of a user indicated by the statistical information 183 compiled by the compiling module 102 on the display module 17. With this, the display device 1 can provide content that the user is likely to be interested in among a plurality of contents included in the content data 181.

More specifically, the display controller 103 reads content belonging to an attribute the display time of which is long among display times for attributes compiled by the compiling module 102 based on the meta information attached to the content data 181 and the like. The display controller 103 then displays on the display module 17 the content as content matching with the preference of a user. For example, when the display time of a category “politics” is long, the display controller 103 reads content belonging to the category “politics” based on the meta information attached to the content data 181 and displays the content on the display module 17. When there are a plurality of corresponding contents, content of which sub-category also matches is preferentially displayed.

The display controller 103 may read content relating to a term the display time of which is long among display times for terms compiled by the compiling module 102 based on the meta information attached to the content data 181 and the like, and displays on the display module 17 the content as content matching with the preference of a user. For example, when the display time of content including a term “currency exchange” is long, the display controller 103 reads content including the term “currency exchange” and content belonging to the category “economics” including “currency exchange” based on the meta information attached to the content data 181 and displays the content on the display module 17. If there are a plurality of corresponding contents, content of which another term (for example, “interest rate”) also matches is preferentially displayed.

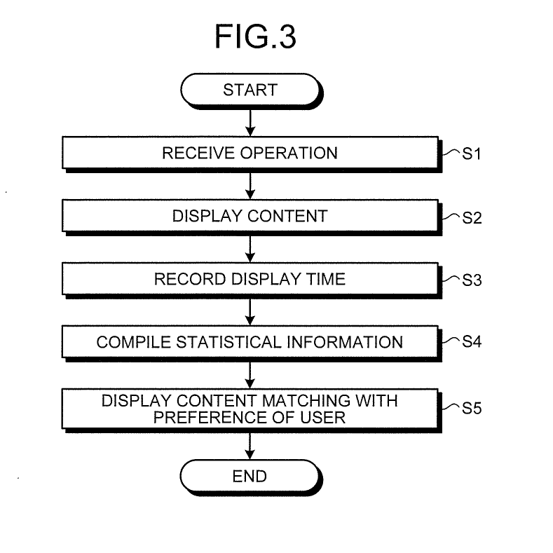

Next, a description will be given of an operation flow performed by the display device 1 under the control of the CPU 10. FIG. 3 is a flowchart of the operation of the display device 1 of the embodiment.

As illustrated in FIG. 3, in the display device 1, the operation input module 13 receives an operation input from a user through the touch panel 14 or the operation button 15 (S1). For example, at S1, a list of contents included in the content data 181 stored in the storage module 18 is displayed on the display module 17, and the operation input module 13 receives a selection of content to be displayed. Next, in the display device 1, content specified to be displayed by an operation from the user is read from the content data 181 stored in the storage module 18 and displayed on the display module 17 (S2).

The recorder 101 measures the display time of content that is being displayed on the display module 17 and records the measured display time in the display time information 182 of the storage module 18 together with a content ID indicating the content that is being displayed and the like (S3). The compiling module 102 compiles statistical information relating to the preference of the user based on the display time recorded for each content in the display time information 182 (S4). The compiled statistical information is stored in the storage module 18 as the statistical information 183.

Thereafter, the display controller 103 displays, from among contents included in the content data 181 stored in the storage module 18, content matching with the preference of the user indicated by the statistical information 183 compiled by the compiling module 102 on the display module 17 (S5). The time at which S5 is performed, i.e., the time at which the display controller 103 displays the content matching with the preference of the user on the display module 17, may be a time point at which an operation for displaying the content matching with the preference of the user is performed. The time may also be a time point at which the content matching with the preference of the user is displayed in an information window displayed without a specific instruction from a user.

In the following, examples will be described in which an advertisement, a learning exercise, an article relating to a tourist site or sightseeing, and a digest of articles are displayed as modes of displaying content matching with the preference of a user.

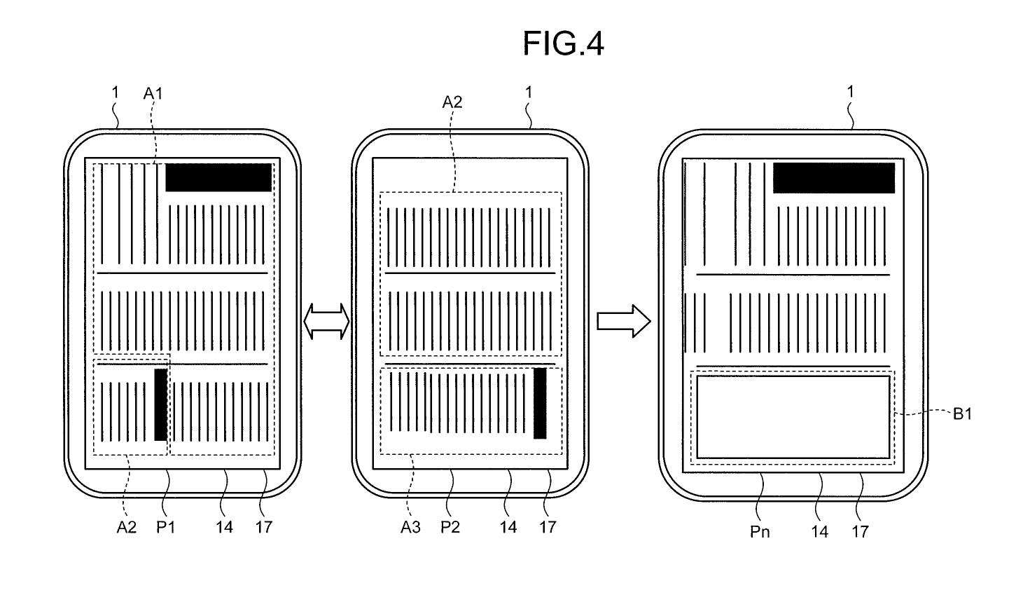

An example will be described in which an advertisement is displayed. FIG. 4 illustrates an example of display of an advertisement B1 matching with the preference of a user. As illustrated in FIG. 4, in the display device 1, by the process from S1 to S3 in FIG. 3, the display times of articles A1 to A3 in an electronic book including pages P1 and P2, such as a newspaper, are recorded in the display time information 182.

It is assumed herein that the display time of the article A1 that belongs to a category “economics” and includes terms “currency exchange”, “stock price” and the like is the longest. In this case, in the display device 1, at S4 in FIG. 3, it is determined that the display time relating to the category “economics” and the terms “currency exchange”, “stock price” and the like is long and for which a user has a strong preference.

Accordingly, at S5 in FIG. 3, as illustrated in FIG. 4, as the advertisement B1 as content displayed on a lower portion of a screen of the display module 17, an advertisement that relates to the category “economics” and the terms “currency exchange”, “stock price” and the like is selected in a page Pn from the content data 181. In this manner, the display device 1 displays the advertisement B1 matching with the preference of the user, thereby enhancing an advertisement effect.

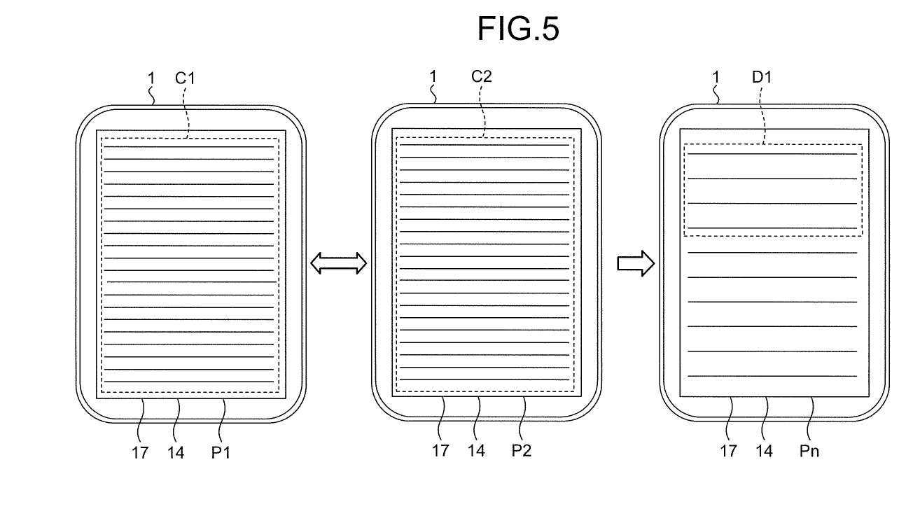

An example will be described in which a learning exercise is displayed. FIG. 5 illustrates an example of display of a learning exercise D1 matching with the preference of a user. As illustrated in FIG. 5, in the display device 1, by the process from S1 to S3 in FIG. 3, the display times of learning units C1 and C2 and the like in an electronic book such as a study-aid book are recorded in the display time information 182.

It is assumed herein that the display time of the learning unit C2 that belongs to a category “mathematics” and includes terms “differential”, “integration” and the like is the longest. In this case, in the display device 1, at S4 in FIG. 3, it is determined that the display time relating to the category “mathematics” and the terms “differential”, “integration” and the like is long and for which a user has a strong preference.

Accordingly, at S5 in FIG. 3, as illustrated in FIG. 5, as the learning exercise D1 displayed on the display module 17 in response to an operation from a user, a learning exercise that relates to the category “mathematics” and the terms “differential”, “integration” and the like is selected from the content data 181. In this manner, the display device 1 displays the learning exercise D1 relating to the learning unit C2 the display time of which becomes long to learn sufficiently, thereby enhancing a learning effect.

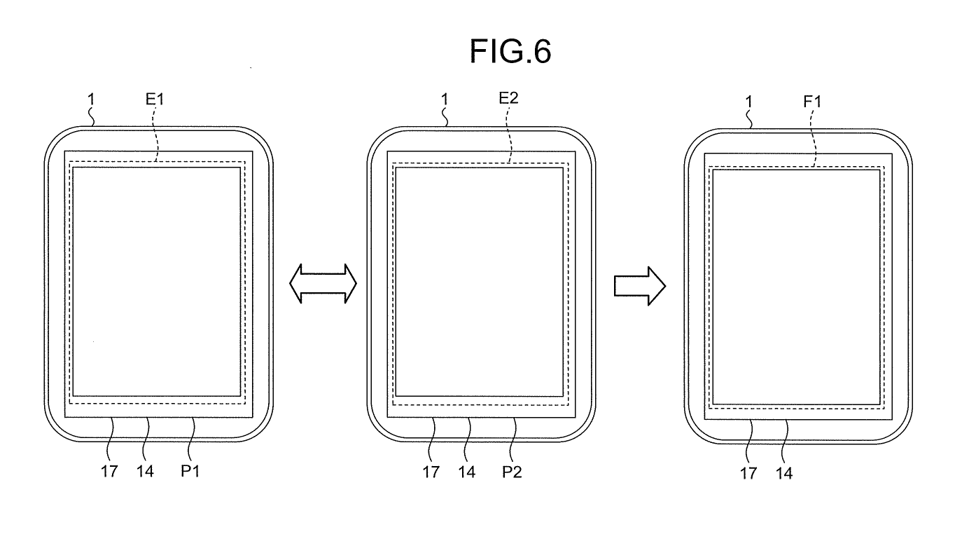

An example will be described in which an article relating to tourist site is displayed. FIG. 6 illustrates an example of display of an article F1 matching with the preference of a user. As illustrated in FIG. 6, in the display device 1, by the process from S1 to S3 in FIG. 3, the display times of articles E1, E2 and the like in an electronic book such as a travel guidebook are recorded in the display time information 182.

It is assumed herein that the display time of the article E2 that belongs to a category “mountain” and includes terms “mountain Y”, “highland Z”, and the like is the longest. In this case, in the display device 1, at S4 in FIG. 3, it is determined that the display time relating to the category “mountain” and the terms “mountain Y”, “highland Z” and the like is long and for which a user has a strong preference.

Accordingly, at S5 in FIG. 3, as illustrated in FIG. 6, as the article F1 as content matching with the preference of a user displayed on the display module 17, an article (tourist information) relating to a tourist site that relates to the category “mountain” and the terms “mountain Y”, “highland Z” and the like is selected from the content data 181. In this manner, the display device 1 displays the article F1 matching with the preference of the user, thereby providing an article relating to a tourist site that the user is likely to be interested in.

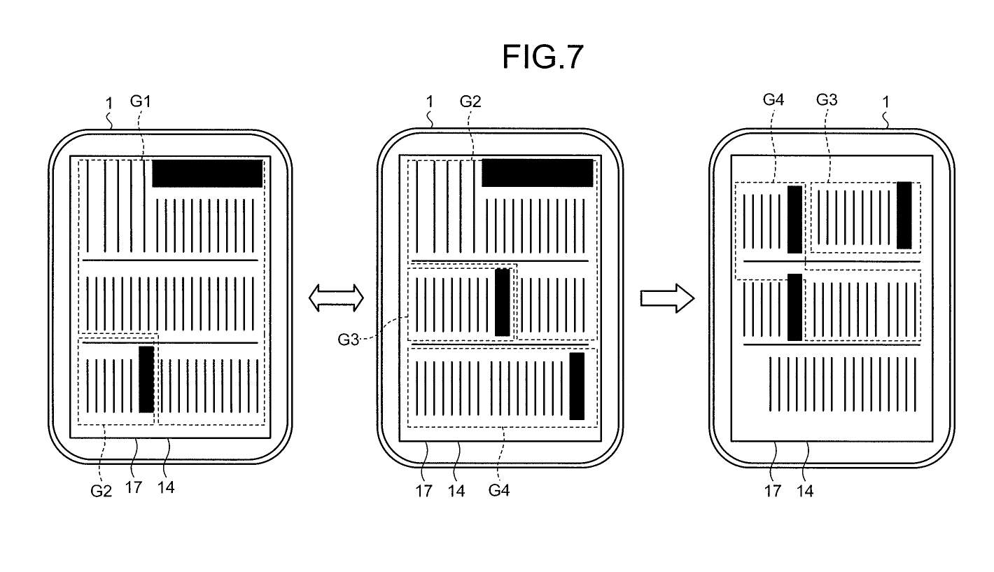

An example will be described in which a digest of articles is displayed. FIG. 7 illustrates an example of display of a digest of an article G3 and an article G4 matching with the preference of a user. As illustrated in FIG. 7, in the display device 1, by the process from S1 to S3 in FIG. 3, the display times of articles G1 to G4 and the like in an electronic book such as a newspaper are recorded in the display time information 182.

It is assumed herein that the display time of a page including the articles G2 to G4 is long and in particular, the articles G3 and G4 are enlarged to be displayed. In this case, in the display device 1, at S4 in FIG. 3, it is determined that the display time relating to a category relating to the articles G3 and G4 and terms included in the articles G3 and G4 is long and for which a user has a strong preference.

Accordingly, at S5 in FIG. 3, as illustrated in FIG. 7, a digest obtained by extracting titles and headlines in the articles G3 and G4 is displayed as a digest of articles matching with the preference of a user on the display module 17. In this manner, the display device 1 displays the digest of the articles G3 and G4 matching with the preference of the user, thereby guiding the user to articles that the user is likely to be interested in.

The advertisement, the learning exercise, the article relating to the tourist site, and the digest of articles as described above may be displayed based on the statistical information 183 delivered from the server 3. If content that the user is likely to be interested in is displayed based on the statistical information 183 delivered from the server 3, the advertisement, the learning exercise, the article relating to a tourist site, or the digest of articles is displayed depending on which content a plurality of users frequently browse.

A computer program may be executed on a computer to realize the same function as the display device 1. The computer program may be provided as being stored in advance in ROM or the like. The computer program may also be provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The computer program may also be stored in a computer connected via a network such as the Internet so that it can be downloaded therefrom via the network. Further, the computer program may be provided or distributed via a network such as the Internet.

The computer program comprises modules that implement the elements described above (the recorder 101, the compiling module 102, and the display controller 103). As real hardware, the CPU (processor) loads the computer program from the ROM into the main memory and executes it. With this, the above elements are implemented on the main memory.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
an operation module configured to receive an operation from a user;
a display module configured to display content in accordance with the operation;
a recorder configured to measure display time of the content that is being displayed and record the display time for each content;
a compiling module configured to compile statistical information relating to a preference of the user based on the display time recorded for each content; and
a display controller configured to display, among contents that have been previously stored, content matching with the preference of the user indicated by the statistical information on the display module.

2. The display device of claim 1, further comprising:
a transmitter configured to transmit the statistical information to another device; and
a receiver configured to receive statistical information from the other device, wherein
the display controller is configured to display content matching with the preference of the user indicated by the statistical information received by the receiver on the display module.

3. The display device of claim 1, wherein
the compiling module is configured to compile display time of contents belonging to each attribute, and
the display controller is configured to display content belonging to an attribute display time of which is long among compiled display times for respective attributes on the display module.

4. The display device of claim 1, wherein
the recorder is configured to record a term in the content that is being displayed as a term relating to the content together with the display time,
the compiling module is configured to compile display time of each term relating to content display time of which is recorded, and
the display controller is configured to display content relating to a term display time of which is long among compiled display times for respective terms on the display module.

5. The display device of claim 1, wherein the display controller is configured to display, among pieces of advertisement information that have been previously stored, advertisement information matching with the preference of the user indicated by the statistical information on the display module.

6. The display device of claim 1, wherein the display controller is configured to display, among learning exercises that have been previously stored, a learning exercise matching with the preference of the user indicated by the statistical information on the display module.

7. The display device of claim 1, wherein the display controller is configured to display, among pieces of sightseeing information that have been previously stored, sightseeing information matching with the preference of the user indicated by the statistical information on the display module.

8. The display device of claim 1, wherein the display controller is configured to display, among articles that have been previously stored, a digest of articles matching with the preference of the user indicated by the statistical information on the display module.

9. A display method applied to a display device that comprises an operation module configured to receive an operation from a user, a display module configured to display content in accordance with the operation, a recorder, a compiling module, and a display controller, the display method comprising:
measuring, by the recorder, display time of the content that is being displayed and recording the display time for each content;
compiling, by the compiling module, statistical information relating to a preference of the user based on the display time recorded for each content; and
displaying, by the display controller, among contents that have been previously stored, content matching with the preference of the user indicated by the statistical information on the display module.
